(19) United States
(12) Patent Application Publication
(10) Pub. No.: US 2026/0099414 A1
(43) Pub. Date: Apr. 9, 2026

(54) MODEL SIZE CALCULATION DEVICE, MODEL SIZE CALCULATION METHOD, AND NON-TRANSITORY COMPUTER READABLE MEDIUM STORING MODEL SIZE CALCULATION PROGRAM FOR SUPPORTING DECISION MAKING

(71) Applicant: NEC Corporation, Tokyo (JP)

(72) Inventors: Kosuke AKIMOTO, Tokyo (JP); Masafumi Oyamada, Tokyo (JP)

(73) Assignee: NEC Corporation, Tokyo (JP)

(21) Appl. No.: 19/338,296

(22) Filed: Sep. 24, 2025

(30) Foreign Application Priority Data
Oct. 8, 2024 (JP) 2024-176661

(51) Int. Cl. G06F 11/30; G06F 11/34

(52) U.S. Cl. CPC G06F 11/3051; G06F 11/3447

(57) ABSTRACT

A model size calculation device includes an acquisition unit for acquiring a first calculation resource amount that is a constraint on a calculation resource amount used for learning processing of a language model for a target language and a target language resource amount that is a resource amount of the target language available for the learning processing, a prediction unit for predicting a first ideal model size that is a model size for further improving a performance index of the language model in the learning processing using the first calculation resource amount in a case where the resource amount of the target language is a first ideal amount according to the first calculation resource amount, and a calculation unit for calculating a target model size according to the first calculation resource amount and the target language resource amount with reference to the first ideal model size.

### INCORPORATION BY REFERENCE

This application is based upon and claims the benefit of priority from Japanese patent application No. 2024-176661, filed on Oct. 8, 2024, the disclosure of which is incorporated herein in its entirety by reference.

### TECHNICAL FIELD

The present disclosure relates to a model size calculation device, a model size calculation method, and a non-transitory computer readable medium storing a model size calculation program.

### BACKGROUND ART

A technique related to setting of a model scale in machine learning is known. For example, WO 2019/234810 A1 discloses a learning device that determines the size of a neural network model in accordance with constraints on hardware resources in learning using a neural network.

### SUMMARY

However, in the learning device described in WO 2019/234810 A1, learning of a language model is not assumed. In the learning of the language model, in order to achieve better performance, as an example, it is desirable to determine an appropriate model size in consideration of the amount of text corpus used for learning. Therefore, a technique for efficiently setting an appropriate model size in learning of a language model is required.

The present disclosure has been made in view of the above problems, and an example object thereof is to provide a technique for efficiently setting an appropriate model size in learning of a language model.

A model size calculation device according to an example aspect of the present disclosure includes an acquisition means for acquiring a first calculation resource amount that is a constraint on a calculation resource amount used for learning processing of a language model for a target language and a target language resource amount that is a resource amount of the target language available in the learning processing, a prediction means for, in a case where the resource amount of the target language is a first ideal amount according to the first calculation resource amount, predicting a first ideal model size that is a model size for further improving a performance index of the language model in the learning processing using the first calculation resource amount, and a calculation means for calculating a target model size according to the first calculation resource amount and the target language resource amount with reference to the first ideal model size.

A model size calculation method according to an example aspect of the present disclosure includes acquisition processing of acquiring, by at least one processor, a first calculation resource amount that is a constraint on a calculation resource amount used for learning processing of a language model for a target language and a target language resource amount that is a resource amount of the target language available in the learning processing, prediction processing of predicting, by the at least one processor in a case where the resource amount of the target language is a first ideal amount according to the first calculation resource amount, a first ideal model size that is a model size for further improving a performance index of the language model in the learning processing using the first calculation resource amount, and calculation processing of calculating, by the at least one processor, a target model size according to the first calculation resource amount and the target language resource amount with reference to the first ideal model size.

A model size calculation program according to an example aspect of the present disclosure is a program for causing a computer to function as a model size calculation device, the program causing the computer to function as an acquisition means for acquiring a first calculation resource amount that is a constraint on a calculation resource amount used for learning processing of a language model for a target language and a target language resource amount that is a resource amount of the target language available in the learning processing, a prediction means for predicting, in a case where the resource amount of the target language is a first ideal amount according to the first calculation resource amount, a first ideal model size that is a model size for further improving a performance index of the language model in the learning processing using the first calculation resource amount, and a calculation means for calculating a target model size according to the first calculation resource amount and the target language resource amount with reference to the first ideal model size.

According to an example aspect of the present disclosure, there is an example effect that a technique for efficiently setting an appropriate model size in learning of a language model can be provided.

### BRIEF DESCRIPTION OF DRAWINGS

The above and other aspects, features and advantages of the present disclosure will become more apparent from the following description of certain exemplary embodiments when taken in conjunction with the accompanying drawings, in which:

FIG. 1 is a block diagram illustrating a configuration of a model size calculation device according to the present disclosure;

FIG. 2 is a flowchart illustrating a flow of a model size calculation method according to the present disclosure;

FIG. 3 is a graph illustrating a relationship between a unique amount of a text corpus of a target language and a loss according to the present disclosure;

FIG. 4 is a block diagram illustrating a configuration of a model size calculation device according to the present disclosure;

FIG. 5 is a flowchart illustrating a flow of a model size calculation method according to the present disclosure; and

FIG. 6 is a block diagram illustrating a configuration of a computer that functions as a model size calculation device according to the present disclosure.

### EXAMPLE EMBODIMENT

Hereinafter, example embodiments of the present disclosure will be exemplified. However, the present disclosure is not limited to the following illustrative example embodiments, and various modifications can be made within a scope described in the claims. For example, example embodiments obtained by appropriately combining technologies (some or all of things or methods) adopted in the following illustrative example embodiments can also be included in the scope of the present disclosure. Example embodiments obtained by appropriately omitting some of the technologies adopted in the following illustrative example embodiments can also be included in the scope of the present disclosure. Effects mentioned in the following illustrative example embodiments are examples of effects expected in the illustrative example embodiments, and do not define extension of the present disclosure. In other words, example embodiments that do not provide the effects mentioned in the following illustrative example embodiments can also be included in the scope of the present disclosure.

### First Illustrative Example Embodiment

A first illustrative example embodiment that is an example of the example embodiments of the present disclosure will be described in detail with reference to the drawings. The present illustrative example embodiment is a basic form of each illustrative example embodiment to be described below. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technology illustrated in the drawings referred to for describing the present illustrative example embodiment can also be adopted in another illustrative example embodiment included in the present disclosure within a range in which no particular technical problem occurs.

### (Configuration of Model Size Calculation Device 1)

A configuration of a model size calculation device 1 will be described with reference to FIG. 1. FIG. 1 is a block diagram illustrating a configuration of the model size calculation device 1. As illustrated in FIG. 1, the model size calculation device 1 includes an acquisition unit 11, a prediction unit 12, and a calculation unit 13. The acquisition unit 11, the prediction unit 12, and the calculation unit 13 are examples of configurations that implement the acquisition means, the prediction means, and the calculation means in the present illustrative example embodiment.

### (Acquisition Unit 11)

The acquisition unit 11 acquires a first calculation resource amount that is a constraint on a calculation resource amount used for the learning processing of the language model for the target language and a target language resource amount that is a resource amount of the target language available in the learning processing of the language model. The acquisition unit 11 supplies the acquired first calculation resource amount to the prediction unit 12. The acquisition unit 11 supplies the acquired target language resource amount to the calculation unit 13.

### (Prediction Unit 12)

in a case where the resource amount of the target language is a first ideal amount according to the first calculation resource amount, the prediction unit 12 predicts a first ideal model size that is a model size for further improving the performance index of the language model in the learning processing using the first calculation resource amount. The prediction unit 12 supplies the predicted first ideal model size to the calculation unit 13.

Here, the first ideal amount is an ideal resource amount of the target language in the learning processing of the language model for the target language using the first calculation resource amount, and is, for example, a resource amount of the target language that can be regarded as “sufficiently large”. The “sufficiently large” resource amount may be, for example, a resource amount at which the improvement in the performance index of the language model tends to converge with respect to the increase in the resource amount of the target language. It is known that such an ideal resource amount is an amount relevant to a calculation resource amount used in the learning processing. For example, the first ideal amount according to the first calculation resource amount may be determined based on the resource amount of another language used in the learning processing using the first calculation resource amount with respect to the trained language model for the other language. Such another language is desirably a language having more available resource amount than the target language.

For example, the prediction unit 12 may search for the first ideal model size for further improving the performance index while executing the learning processing using the target language of the first ideal amount under the constraint on the first calculation resource amount.

In order to predict the first ideal model size, the prediction unit 12 may not necessarily actually execute learning processing using the target language of the first ideal amount under the constraint on the first calculation resource amount. For example, the prediction unit 12 may predict the first ideal model size according to the first calculation resource amount based on the tendency of the change in the ideal model size with respect to the calculation resource amount. As a tendency of such a change, for example, the following Expression (1) derived based on Reference Literature 1 can be adopted. However, the tendency of the change is not limited to Expression (1).

Reference Literature 1: Hoffmann, Jordan, et al. “Training compute-optimal large language models.” arXiv preprint arXiv:2203.15556 (2022)

$$N = a * C \hat{} b \qquad ( 1 )$$

Here, Nis an ideal model size, C is a calculation resource amount, and a and b are coefficients. “*” indicates multiplication, and “\hat{ }” indicates exponent operation.

### (Calculation Unit 13)

The calculation unit 13 calculates the target model size according to the first calculation resource amount and the target language resource amount with reference to the first ideal model size. For example, the calculation unit 13 may set the first ideal model size as the target model size. For example, the calculation unit 13 may calculate the target model size using a calculation model to which the first ideal model size and the target language resource amount are input.

### (Effects of Model Size Calculation Device 1)

As described above, the model size calculation device 1 employs a configuration including the acquisition unit 11 that acquires the first calculation resource amount that is a constraint on the calculation resource amount used for the learning processing of the language model for the target language and the target language resource amount that is the resource amount of the target language available for the learning processing, the prediction unit 12 that predicts the first ideal model size that is the model size for further improving the performance index of the language model in the learning processing using the first calculation resource amount in a case where the resource amount of the target language is the first ideal amount according to the first calculation resource amount, and the calculation unit 13 that calculates the target model size according to the first calculation resource amount and the target language resource amount with reference to the first ideal model size.

Therefore, according to the model size calculation device 1, it is possible to efficiently set an appropriate model size in learning of the language model.

### (Flow of Model Size Calculation Method)

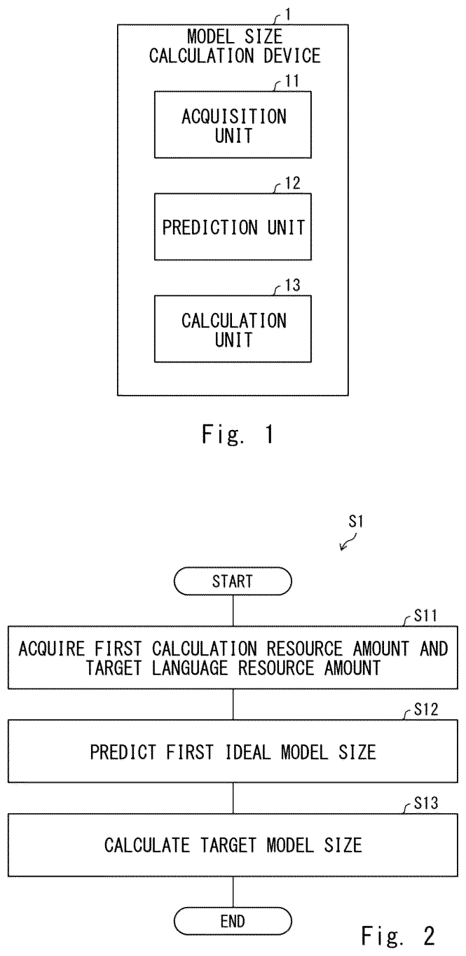

A flow of a model size calculation method S1 will be described with reference to FIG. 2. FIG. 2 is a flowchart illustrating a flow of the model size calculation method S1. As illustrated in FIG. 2, the model size calculation method S1 includes acquisition processing S11, prediction processing S12, and calculation processing S13.

### (Acquisition Processing S11)

In the acquisition processing S11, the acquisition unit 11 acquires a first calculation resource amount that is a constraint on a calculation resource amount used for the learning processing of the language model for the target language and a target language resource amount that is a resource amount of the target language available in the learning processing of the language model. The acquisition unit 11 supplies the acquired first calculation resource amount to the prediction unit 12. The acquisition unit 11 supplies the acquired target language resource amount to the calculation unit 13.

### (Prediction Processing S12)

In the prediction processing S12, in a case where the resource amount of the target language is a first ideal amount according to the first calculation resource amount, the prediction unit 12 predicts a first ideal model size that is a model size for further improving the performance index of the language model in the learning processing using the first calculation resource amount. The prediction unit 12 supplies the predicted first ideal model size to the calculation unit 13.

### (Calculation Processing S13)

In the calculation processing S13, the calculation unit 13 calculates the target model size according to the first calculation resource amount and the target language resource amount with reference to the first ideal model size.

### (Effect of Model Size Calculation Method S1)

As described above, the model size calculation method S1 employs a configuration including the acquisition processing S11 of acquiring, by the acquisition unit 11, the first calculation resource amount that is a constraint on the calculation resource amount used for the learning processing of the language model for the target language and the target language resource amount that is the resource amount of the target language available for the learning processing, the prediction processing S12 of predicting, by the prediction unit 12, the first ideal model size that is the model size for further improving the performance index of the language model in the learning processing using the first calculation resource amount in a case where the resource amount of the target language is the first ideal amount according to the first calculation resource amount, and the calculation processing S13 of calculating, by the calculation unit 13, the target model size according to the first calculation resource amount and the target language resource amount with reference to the first ideal model size. Therefore, according to the model size calculation method S1, effects similar to those of the model size calculation device 1 described above can be obtained.

### Second Illustrative Example Embodiment

A second illustrative example embodiment that is an example of the example embodiments of the present disclosure will be described in detail with reference to the drawings. Components that have the same functions as the components described in the above-described illustrative example embodiment are denoted by the same reference signs, and description of the components will be appropriately omitted. An application range of each technology adopted in the present illustrative example embodiment is not limited to the present illustrative example embodiment. In other words, each technology adopted in the present illustrative example embodiment can also be adopted in another illustrative example embodiment included in the present disclosure within a range in which no particular technical problem occurs. Each technique illustrated in each of the drawings referred to for description of the present illustrative example embodiment can be employed in the other illustrative example embodiments included in the present disclosure within a range in which no particular technical problem occurs.

Learning a language model (hereinafter, also referred to as “LLM (Large Language Models)”) requires a large text corpus. However, languages other than English have a relatively small text corpus. Therefore, the following method is known as a method for training a language model using a language having a small resource amount of a text corpus as a target language.
Method of performing learning by repeatedly using the same text corpus a plurality of times (multi-epoch learning)
Method of performing learning using a text corpus of another language different from the target language in addition to a text corpus of the target language (multilingual learning)
Method of performing two-stage learning by changing in stages a language ratio between a target language and another language in multilingual learning (two-stage learning)

However, in a case where the language model is trained by combining the above-described methods, the learning setting (hyperparameter) increases, and thus, the cost increases if exhaustive search is performed.

Therefore, the engineer who trains the language model has heuristically narrowed down the search space based on the analysis result obtained in the past regarding the performance change of the language model by the learning setting. However, the analysis related to the learning setting of the language model performed in the past is limited, and there is a problem that the optimal search space cannot be narrowed in a case where the LLM is trained by combining the above-described methods.

Therefore, the inventors of the present disclosure have conducted studies to narrow down a search space of a learning setting expected to obtain high performance in a case where a language model having a language with a small resource amount as a target language is trained by using a combination of a part or all of the multi-epoch learning, the multilingual learning, and the two-stage learning described above.

As an example, the inventor of the present disclosure has obtained knowledge that even if the resource amount of the target language used in the LLM learning processing changes, the optimal model size of the LLM is not different from the case where it can be considered that the resource amount of the target language is sufficient.

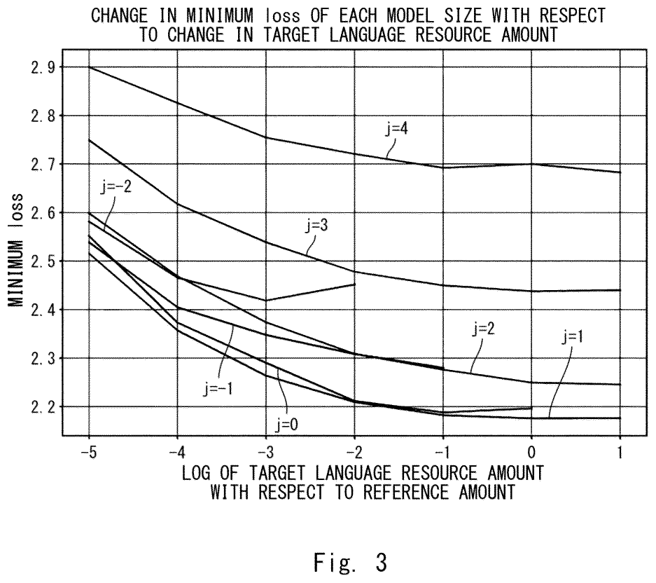

FIG. 3 illustrates a graph that is the basis of the findings obtained by the present inventors. FIG. 3 is a graph illustrating a relationship between the unique amount of the text corpus of the target language and the minimum value of the loss (an example of the performance index) for each model size. The graph is obtained by a trial of learning processing in which Japanese is applied as an example of the target language, multilingual learning including Japanese and English is applied as an example of the LLM learning processing, and learning settings are variously changed.

In FIG. 3, the horizontal axis indicates the unique amount of the text corpus of the target language, and is represented by a relative amount with respect to a reference amount (more specifically, a logarithm with a base of 2 with respect to the reference amount). The vertical axis is the minimum value of the loss of an LLM that can be achieved in the unique amount of the relevant text corpus. The loss is an example of a performance index, and a smaller value indicates better performance of the LLM.

In the trial of the learning processing, each of one-stage learning and two-stage learning is performed as a change in learning setting. In the one-stage learning, the ratio of Japanese used during the learning processing has been constant, and in the two-stage learning, the ratio of Japanese has been increased stepwise. As a change in the learning setting, the model size of the LLM, the number of training steps, the ratio of the target language, and the like have been further changed in the one-stage learning. As a change in the learning setting, the model size of the LLM, the total number of training steps, the ratio of the length of the first stage learning, the ratio of the target language in the first stage and the second stage, and the like have been further changed in the two-stage learning. The calculation resource amount has been the same regardless of a change in learning setting.

The graph of FIG. 3 has been obtained by connecting sets of the unique amount and the loss of the text corpus obtained in the trial of the learning processing for each model size. In FIG. 3, j represents the model size, and is represented by a relative amount with respect to the reference size (more specifically, logarithm with a base of 2 with respect to the reference size).

As can be seen from the graph of FIG. 3, regardless of the change in the unique amount of the text corpus, the minimum value of the loss is achieved with a model size of j=1. Although not illustrated in FIG. 3, it has been found that, also in the trial in which the calculation resource amount is fixed to be different from the calculation resource amount applied in the trial in which the graph of FIG. 3 is obtained, the minimum value of the loss is achieved with a specific model size regardless of the change in the unique amount of the text corpus. The model size at which the minimum value of the loss is achieved according to the fixed calculation resource amount is not necessarily j=1, but is a specific model size. That is, it has been found that even if the resource amount of the target language changes under the constraint on the same calculation resource amount, the optimal model size of the LLM is not different from the case where it can be considered that the resource amount of the target language is sufficient.

A model size calculation device 1A and each processing by the model size calculation device 1A to be described below are based on the above-described knowledge, and are based on a viewpoint unique to the inventor.

### (Outline of Model Size Calculation Device 1A)

The model size calculation device 1A is a device that calculates an appropriate model size in the learning of the LLM for the target language. The appropriate model size is a model size with which the performance index is further improved. The performance index may be the loss described above. Hereinafter, the “appropriate model size” is also referred to as a target model size.

In the present illustrative example embodiment, a plurality of languages including the target language are used in the learning processing of the LLM for the target language. In other words, multilingual learning is applied as the LLM learning processing. As a result, it is possible to calculate a more appropriate target model size in a case where multilingual learning including the target language is performed.

In the present illustrative example embodiment, it is assumed that the target language is a language (hereinafter, also referred to as a small resource language) whose resource amount is insufficient compared to an ideal amount. An example of such a target language includes, but is not limited to, “Japanese”. The number of other languages used in the multilingual learning may be one or more. In other words, as the learning processing of the LLM for the target language, multilingual learning using two languages may be performed, or multilingual learning using three or more languages may be performed. For example, at least one of the other languages to be used may be a language in which an ideal resource amount can be secured. Examples of such other languages include, but are not limited to, “English”. For example, at least one of the other languages to be used may be another small resource language different from the target language. For example, it is desirable that an ideal resource amount can be secured by the total resource amount available for each language (target language and one or a plurality of other languages) used in the multilingual learning.

In the present illustrative example embodiment, since a small resource language is assumed as the target language, there is a high possibility that the target language resource amount T_unique is less than the first ideal amount. Therefore, in order to predict the first ideal model size, it is difficult to actually execute the learning processing using the target language of the first ideal amount under the first calculation resource amount CR1. Therefore, the model size calculation device 1A predicts the first ideal model size without executing the learning processing using the target language of the first ideal amount under the first calculation resource amount CR1. The model size calculation device 1A calculates the target model size by performing correction based on the smallness of the target language resource amount T_unique on such a first ideal model size. The target model size calculated in this manner can be applied as an appropriate model size according to the first calculation resource amount CR1 and the target language resource amount T_unique in the multilingual learning of the LLM for a small resource language.

The first calculation resource amount CR1, which is a constraint on the calculation resource amount used for the LLM learning processing for the target language, is the resource amount that can be used for the learning processing by the device that performs the LLM learning processing, and as an example, an amount obtained by measuring the total amount of calculation that can be used for the learning processing in units of a floating-point operation (FLOP) can be cited.

The target language resource amount T_unique, which is the resource amount of the target language available in the learning processing, is the unique amount (a quantity that does not include repetition in a case where the number of epochs is more than one) of the text corpus of the target language that has been collected and can be used to perform the LLM learning processing. An example of the target language resource amount T_unique is the unique amount of the text corpus of all the target languages existing on the earth.

The “language” in the present disclosure includes words and sentences used in a specific field (domain) such as dialect and medical care, in addition to natural languages such as Japanese and English.

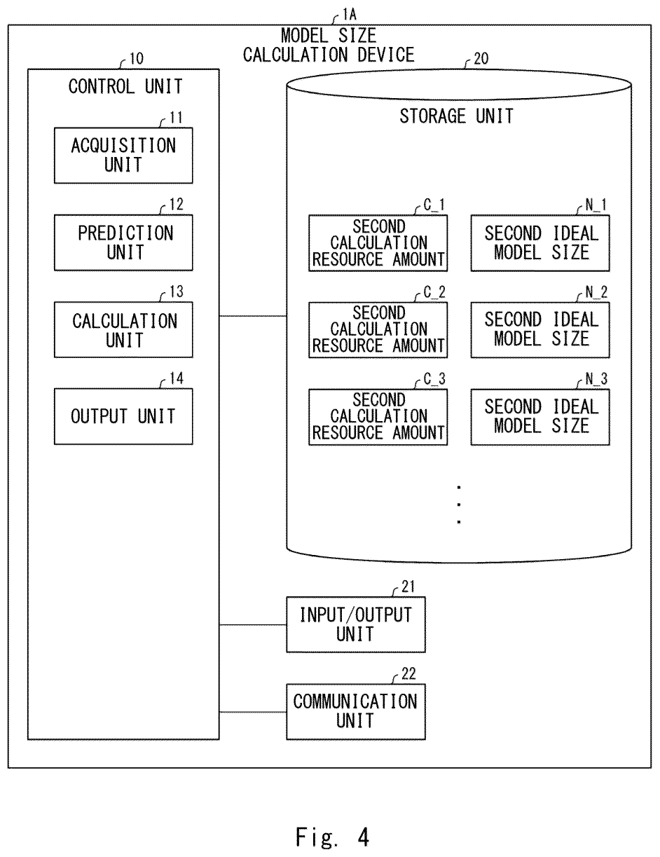

(Configuration of Model Size Calculation Device 1A) A configuration of the model size calculation device 1A will be described with reference to FIG. 4. FIG. 4 is a block diagram illustrating a configuration of the model size calculation device 1A. As illustrated in FIG. 4, the model size calculation device 1A includes a control unit 10, a storage unit 20, an input/output unit 21, and a communication unit 22.

### (Storage Unit 20)

The storage unit 20 stores data to be referred to by the control unit 10. As an example, the storage unit 20 stores second calculation resource amounts C_1, C_2, C_3, . . . , and second ideal model sizes N_1, N_2, N_3, . . . . Although not illustrated, the storage unit 20 may store the LLM, the text corpus of the target language and other languages, the first calculation resource amount CR1, and the target language resource amount T_unique. Some or all of the data stored in the storage unit 20 may be stored in advance, or may be stored by each processing by the control unit 10. Some or all of the data stored in the storage unit 20 may be stored in an external device communicable with the model size calculation device 1A.

### (Input/Output Unit 21)

The input/output unit 21 is an interface with an input device that receives an input of data and an output device that outputs data. Examples of the input device include, but are not limited to, a microphone, a camera, a line-of-sight input device, a keyboard, and a touch pad. Examples of the output device include, but are not limited to, a speaker and a liquid crystal display.

### (Communication Unit 22)

The communication unit 22 is an interface for transmitting and receiving data via a network. Examples of the communication unit 22 include, but are not limited to, communication chips in various communication standards such as Ethernet (registered trademark), Wi-Fi (registered trademark), and wireless communication standards of mobile data communication networks, and connectors compliant with USB.

### (Control Unit 10)

The control unit 10 controls each component included in the model size calculation device 1A. As illustrated in FIG. 4, the control unit 10 includes an acquisition unit 11, a prediction unit 12, a calculation unit 13, and an output unit 14. The acquisition unit 11, the prediction unit 12, the calculation unit 13, and the output unit 14 are examples of configurations that implement the acquisition means, the prediction means, the calculation means, and the output means in the present illustrative example embodiment.

### (Acquisition Unit 11)

The acquisition unit 11 is configured as follows in addition to being configured similar to that in the first illustrative example embodiment. For example, the acquisition unit 11 acquires data supplied from the input/output unit 21 or the communication unit 22. As an example, the acquisition unit 11 acquires the first calculation resource amount CR1 and the target language resource amount T_unique.

### (Prediction Unit 12)

The prediction unit 12 is configured as follows in addition to being configured similar to that in the first illustrative example embodiment. In a case where the resource amount of the target language is a second ideal amount according to the second calculation resource amount different from the first calculation resource amount, the prediction unit 12 calculates the second ideal model size for further improving the performance index of the language model in the learning processing using the second calculation resource amount. The prediction unit 12 also refers to the second calculation resource amount and the second ideal model size to predict the first ideal model size. As a result, in order to predict the first ideal model size, it is not necessary to execute learning processing using the target language of the first ideal amount under the constraint on the first calculation resource amount. It is beneficial that the learning processing does not need to be executed, for example, in a case where the target language resource amount is less than the first ideal amount.

For example, the second calculation resource amount is an amount smaller than the first calculation resource amount. As described above, the resource amount of the ideal target language in the learning processing of the language model for the target language is an amount relevant to the calculation resource amount used in the learning processing. For example, the smaller the calculation resource amount, the smaller the ideal resource amount may be. Therefore, the second calculation resource amount in which the second ideal amount relevant to the second calculation resource amount is smaller than the target language resource amount T_unique is applied as the second calculation resource amount. As a result, the prediction unit 12 can search for the second ideal model size while actually executing the learning processing using the target language of the second ideal amount under the constraint on the second calculation resource amount. The second ideal amount according to the second calculation resource amount will be described in the same manner as the first ideal amount according to the first calculation resource amount, and thus detailed description will not be repeated.

The prediction unit 12 desirably calculates the second ideal model size for each of the plurality of second calculation resource amounts. As an example, the prediction unit 12 may calculate the second ideal model size N_i for each of the second calculation resource amounts C_i (i=1, 2, 3, . . . ) illustrated in FIG. 4. The prediction unit 12 may fit a function indicating a relationship between the calculation resource amount C and the ideal model size N with a small error by referring to a plurality of pairs of the second calculation resource amount C_i and the second ideal model size N_i. For such fitting, for example, a least squares method may be used, but the present disclosure is not limited thereto. The prediction unit 12 can predict the first ideal model size relevant to the first calculation resource amount using the fitted function.

The fitting function is expressed by Expression (2) as an example.

$$N = a * C \hat{} b \qquad ( 2 )$$

Here, N is an ideal model size, C is a calculation resource amount, and a and b are coefficients. “*” indicates multiplication, and “\hat{ }” indicates exponent operation. In other words, for example, the prediction unit 12 refers to a plurality of pairs of the second calculation resource amount C_i and the second ideal model size N_i, and obtains the coefficients a and b in Expression (2) so as to reduce the error.

Using the fitted Expression (2), the prediction unit 12 can obtain the first ideal model size N_opt by the following Expression (3) as an example.

$$N\_opt = a * CR 1 \hat{} b \qquad ( 3 )$$

The method by which the prediction unit 12 predicts the first ideal model size with reference to the pair of the second calculation resource amount and the second ideal model size is not limited to the example described above.

### (Calculation Unit 13)

The calculation unit 13 performs correction on the first ideal model size according to the target language resource amount T_unique to calculate the target model size according to the first calculation resource amount CR1 and the target language resource amount T_unique. For example, the calculation unit 13 may perform correction in consideration of the smallness of the target language resource amount T_unique. An example of such correction is the following Expression (4).

$$Target model size = N\_opt * ( T\_unique / T\_base ) \hat{} 0.2 \qquad ( 4 )$$

Here, T_base is a reference amount of the target language, and for example, the first ideal amount may be applied, but the present disclosure is not limited thereto. “/” indicates division. The correction performed by the calculation unit 13 is not necessarily limited to Expression (4). As a result, a more appropriate target model size according to the first calculation resource amount CR1 and the target language resource amount T_unique can be obtained.

### (Output Unit 14)

The output unit 14 outputs data via the input/output unit 21 or the communication unit 22. As an example, the output unit 14 outputs the target model size. For example, the output unit 14 may further output the first calculation resource amount CR1 and the target language resource amount T_unique in addition to the target model size. For example, the output unit 14 may further output the first ideal model size N_opt in addition to the target model size. As a result, it is possible to notify the user of an appropriate target model size according to the first calculation resource amount CR1 and the target language resource amount T_unique.

### (Processing Executed by Model Size Calculation Device 1A)

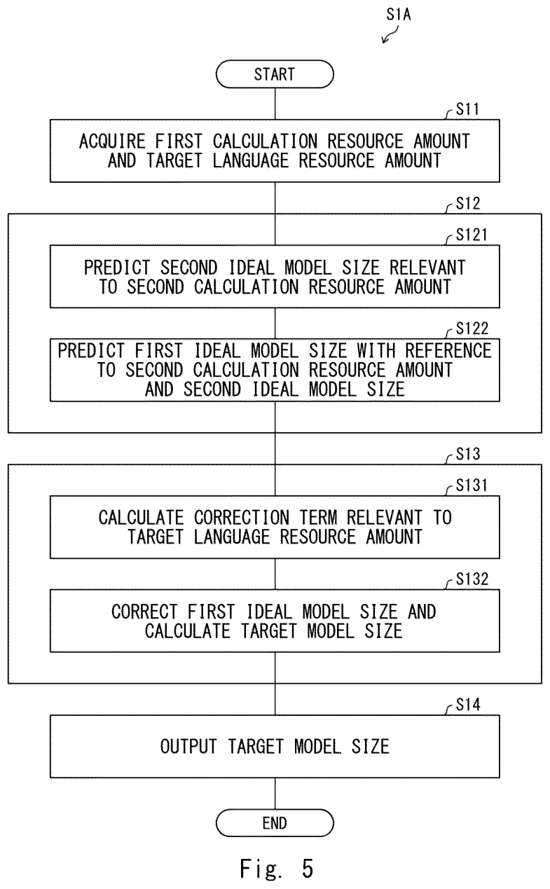

A flow of processing (model size calculation method S1A) executed by the model size calculation device 1A will be described with reference to FIG. 5. FIG. 5 is a flowchart illustrating a flow of a model size calculation method SIA.

### (Acquisition Processing S11)

In the acquisition processing S11, the acquisition unit 11 acquires the first calculation resource amount CR1 and the target language resource amount T_unique.

### (Prediction Processing S12)

In the prediction processing S12, in a case where the resource amount of the target language is the first ideal amount according to the first calculation resource amount CR1, the prediction unit 12 predicts the first ideal model size N_opt for further improving the performance index of an LLM in the learning processing using the first calculation resource amount CR1. As an example, the prediction unit 12 executes the following steps S121 to S122 in the prediction processing S12.

### (Step S121)

In step S121, in a case where the resource amount of the target language is the second ideal amount according to the second calculation resource amount C_i, the prediction unit 12 calculates the second ideal model size N_i for further improving the performance index of the LLM in the learning processing of the LLM using the second calculation resource amount C_i. A specific example of the method of calculating the second ideal model size N_i is as described above, and thus detailed description will not be repeated. As a result, a pair of the second calculation resource amount C_i and the second ideal model size N_i is obtained. Here, it is assumed that a plurality of pairs are obtained.

### (Step S122)

In step S122, the prediction unit 12 refers to a pair of the second calculation resource amount C_i and the second ideal model size N_i to predict the first ideal model size N_opt. The specific example of the technique of predicting the first ideal model size N_opt based on the second calculation resource amount C_i and the second ideal model size N_i is as described above, and thus detailed description will not be repeated.

### (Calculation Processing S13)

In the calculation processing S13, the calculation unit 13 calculates the target model size according to the first calculation resource amount CR1 and the target language resource amount T_unique with reference to the first ideal model size. As an example, the calculation unit 13 executes the following steps S131 to S132 in the calculation processing S13.

### (Step S131)

In step S131, the calculation unit 13 calculates a correction term for correcting the first ideal model size N_opt based on the target language resource amount T_unique. The correction term may be, for example, the second term on the right side of Expression (4).

### (Step S132)

In step S132, the calculation unit 13 calculates the target model size by correcting the first ideal model size N_opt using the calculated correction term.

### (Output Processing S14)

In output processing S14, the output unit 14 outputs the target model size. Since the specific example of the content output by the output unit 14 is as described above, the detailed description will not be repeated.

### (Application Example of Model Size Calculation Device 1A)

For example, the model size calculation device 1A may train the LLM of the target model size using the first calculation resource amount CR1 and the target language resource amount T_unique. As a method of training the LLM of the target model size, a known method may be used. In a case where the model size calculation device 1A trains the LLM, the model size calculation device 1A may train the LLM of the target model size after performing processing of determining various learning settings such as a schedule of a ratio at which the target language is used, the number of epochs, and the like. As a result, it is possible to reduce the search space in which the model size is changed in order to generate a higher-performance LLM.

The model size calculation device 1A may instruct an external device different from the model size calculation device 1A to train the LLM by using the target model size. In this case, the model size calculation device 1A may instruct an external device to narrow a range for selecting various learning settings using the target model size. With this configuration, the model size calculation device 1A can reduce the search space for changing the model size with respect to the external device.

### (Effects of Model Size Calculation Device 1A)

As described above, the model size calculation device 1A adopts a configuration in which a plurality of languages including a target language are used in the learning processing of the language model for the target language. Therefore, according to the model size calculation device 1A, in addition to the effect obtained by the model size calculation device 1, it is possible to obtain a more appropriate target model size in a case where multilingual learning including the target language is performed.

The model size calculation device 1A adopts a configuration in which in a case where the resource amount of the target language is the second ideal amount according to the second calculation resource amount different from the first calculation resource amount, the prediction unit 12 calculates the second ideal model size for further improving the performance index of the language model in the learning processing using the second calculation resource amount, and predicts the first ideal model size with reference to the second calculation resource amount and the second ideal model size. Therefore, according to the model size calculation device 1A, in addition to the effect obtained by the model size calculation device 1, it is possible to obtain an effect that it is not necessary to execute the learning processing using the target language of the first ideal amount under the constraint on the first calculation resource amount in order to predict the first ideal model size.

The model size calculation device 1A employs a configuration in which the calculation unit 13 calculates the target model size by performing correction on the first ideal model size according to the target language resource amount. Therefore, according to the model size calculation device 1A, in addition to the effect obtained by the model size calculation device 1, it is possible to obtain a more appropriate target model size according to the first calculation resource amount and the target language resource amount.

The model size calculation device 1A adopts a configuration in which an output unit 14 that outputs the target model size is further included. Therefore, according to the model size calculation device 1A, in addition to the effect obtained by the model size calculation device 1, it is possible to notify the user of an appropriate target model size according to the first calculation resource amount and the target language resource amount.

### [Achievement Example by Software]

Some or all of the functions of the model size calculation devices 1 and 1A (hereinafter, also referred to as “each of the above devices”) may be implemented by hardware such as an integrated circuit (IC chip) or may be implemented by software.

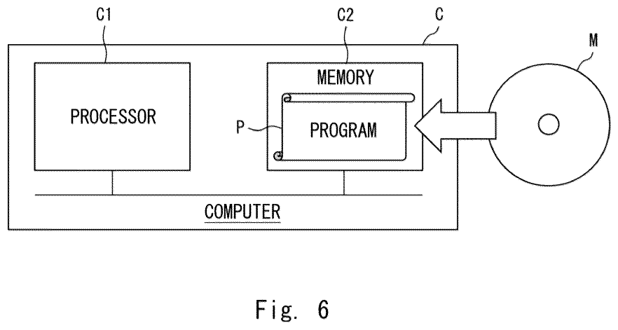

In the latter case, each of the above devices is achieved by, for example, a computer that executes a command of a program as software for achieving each function. An example of such a computer (hereinafter, referred to as a computer C) is illustrated in FIG. 6. FIG. 6 is a block diagram illustrating a hardware configuration of the computer C functioning as each of the above devices.

The computer C includes at least one processor C1 and at least one memory C2. A program P causing the computer C to operate as each of the above devices is recorded in the memory C2. In the computer C, by the processor C1 reading the program P from the memory C2 and executing the program P, each function of each of the above devices is achieved.

As the processor C1, for example, a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these can be used. As the memory C2, for example, a flash memory, a hard disk drive (HDD), a solid state drive (SSD), or a combination of these can be used.

The computer C may further include a random access memory (RAM) for loading the program P at the time of execution and temporarily storing various types of data. The computer C may further include a communication interface for transmitting and receiving data to and from another device. The computer C may further include an input/output interface for connecting input/output devices such as a keyboard, a mouse, a display, and a printer.

The program P can be recorded in a non-transitory tangible recording medium M readable by the computer C. As such a recording medium M, for example, a tape, a disk, a card, a semiconductor memory, or a programmable logic circuit can be used. The computer C can acquire the program P via such a recording medium M. The program P can be transmitted via a transmission medium. As such a transmission medium, for example, a communication network or a broadcast wave can be used. The computer C can also acquire the program P via such a transmission medium.

Each of the above functions of each of the above devices may be achieved by a single processor provided in a single computer, may be achieved in cooperation with a plurality of processors provided in a single computer, or may be achieved in cooperation with a plurality of processors provided in a plurality of computers. The program for causing each of the above devices to achieve each of the above functions may be stored in a single memory provided in a single computer, may be stored in a distributed manner in a plurality of memories provided in a single computer, or may be stored in a distributed manner in a plurality of memories provided in a plurality of computers.

### [Supplementary Information A]

The present disclosure includes technologies described in the following Supplementary Notes. However, the present disclosure is not limited to the techniques described in the following supplementary notes, and various modifications can be made within the scope described in the claims.

### (Supplementary Note A1)

A model size calculation device including:
an acquisition means for acquiring a first calculation resource amount that is a constraint on a calculation resource amount used for learning processing of a language model for a target language and a target language resource amount that is a resource amount of the target language available in the learning processing;
a prediction means for predicting, in a case where the resource amount of the target language is a first ideal amount according to the first calculation resource amount, a first ideal model size that is a model size for further improving a performance index of the language model in the learning processing using the first calculation resource amount; and
a calculation means for calculating a target model size according to the first calculation resource amount and the target language resource amount with reference to the first ideal model size.

### (Supplementary Note A2)

The model size calculation device according to Supplementary Note A1, in which in the learning processing, a plurality of languages including the target language are used.

### (Supplementary Note A3)

The model size calculation device according to Supplementary Note A1 or A2,
in which the prediction means is configured to execute:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

### (Supplementary Note A4)

The model size calculation device according to any one of Supplementary Notes A1 to A3, in which the calculation means is configured to execute calculating the target model size by correcting the first ideal model size according to the target language resource amount.

### (Supplementary Note A5)

The model size calculation device according to any one of Supplementary Notes A1 to A4, in which the calculation means is configured to execute setting the first ideal model size as the target model size.

### (Supplementary Note A6)

The model size calculation device according to any one of Supplementary Notes A1 to A5, further including an output means for outputting the target model size.

### [Supplementary Information B]

The present disclosure includes technologies described in the following Supplementary Notes. However, the present disclosure is not limited to the techniques described in the following supplementary notes, and various modifications can be made within the scope described in the claims.

### (Supplementary Note B1)

A model size calculation method including:
acquisition processing of acquiring, by at least one processor, a first calculation resource amount that is a constraint on a calculation resource amount used for learning processing of a language model for a target language and a target language resource amount that is a resource amount of the target language available in the learning processing;
prediction processing of predicting, by the at least one processor in a case where the resource amount of the target language is a first ideal amount according to the first calculation resource amount, a first ideal model size that is a model size for further improving a performance index of the language model in the learning processing using the first calculation resource amount; and
calculation processing of calculating, by the at least one processor, a target model size according to the first calculation resource amount and the target language resource amount with reference to the first ideal model size.

### (Supplementary Note B2)

The model size calculation method according to Supplementary Note B1, in which in the learning processing, a plurality of languages including the target language are used.

### (Supplementary Note B3)

The model size calculation method according to Supplementary Note B1 or B2, in which in the prediction processing, the at least one processor is configured to execute:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

### (Supplementary Note B4)

The model size calculation method according to any one of Supplementary Notes B1 to B3, in which in the calculation processing, the at least one processor is configured to execute calculating the target model size by correcting the first ideal model size according to the target language resource amount.

### (Supplementary Note B5)

The model size calculation method according to any one of Supplementary Notes B1 to B4, in which in the calculation processing, the at least one processor is configured to execute setting the first ideal model size as the target model size.

### (Supplementary Note B6)

The model size calculation method according to any one of Supplementary Notes B1 to B5, in which the at least one processor is further configured to execute output processing of outputting the target model size.

### [Supplementary Information C]

The present disclosure includes technologies described in the following Supplementary Notes. However, the present disclosure is not limited to the techniques described in the following supplementary notes, and various modifications can be made within the scope described in the claims.

### (Supplementary Note C1)

A model size calculation program for causing a computer to function as a model size calculation device, the program causing the computer to function as:
an acquisition means for acquiring a first calculation resource amount that is a constraint on a calculation resource amount used for learning processing of a language model for a target language and a target language resource amount that is a resource amount of the target language available in the learning processing;
a prediction means for predicting, in a case where the resource amount of the target language is a first ideal amount according to the first calculation resource amount, a first ideal model size that is a model size for further improving a performance index of the language model in the learning processing using the first calculation resource amount; and
a calculation means for calculating a target model size according to the first calculation resource amount and the target language resource amount with reference to the first ideal model size.

### (Supplementary Note C2)

The model size calculation program according to Supplementary Note C1, in which in the learning processing, a plurality of languages including the target language are used.

### (Supplementary Note C3)

The model size calculation program according to Supplementary Note C1 or C2,
in which the prediction means is configured to execute:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

### (Supplementary Note C4)

The model size calculation program according to any one of Supplementary Notes C1 to C3, in which the calculation means is configured to execute calculating the target model size by correcting the first ideal model size according to the target language resource amount.

### (Supplementary Note C5)

The model size calculation program according to any one of Supplementary Notes C1 to C4, in which the calculation means is configured to execute setting the first ideal model size as the target model size.

### (Supplementary Note C6)

The model size calculation program according to any one of Supplementary Notes C1 to C5, in which the computer further functions as an output means for outputting the target model size.

### [Supplementary Information D]

The present disclosure includes technologies described in the following Supplementary Notes. However, the present disclosure is not limited to the techniques described in the following supplementary notes, and various modifications can be made within the scope described in the claims.

### (Supplementary Note D1)

A model size calculation device including:
at least one processor, in which
the at least one processor is configured to execute:
acquisition processing of acquiring a first calculation resource amount that is a constraint on a calculation resource amount used for learning processing of a language model for a target language and a target language resource amount that is a resource amount of the target language available in the learning processing;
prediction processing of predicting, in a case where the resource amount of the target language is a first ideal amount according to the first calculation resource amount, a first ideal model size that is a model size for further improving a performance index of the language model in the learning processing using the first calculation resource amount; and
calculation processing of calculating a target model size according to the first calculation resource amount and the target language resource amount with reference to the first ideal model size.

The model size calculation device may further include a memory. The memory may store a program for causing the at least one processor to execute each of the processing.

### (Supplementary Note D2)

The model size calculation device according to Supplementary Note D1, in which in the learning processing, a plurality of languages including the target language are used.

### (Supplementary Note D3)

The model size calculation device according to Supplementary Note D1 or D2, in which in the prediction processing, the at least one processor is configured to execute:

calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

### (Supplementary Note D4)

The model size calculation device according to any one of Supplementary Notes D1 to D3, in which in the calculation processing, the at least one processor is configured to execute calculating the target model size by correcting the first ideal model size according to the target language resource amount.

### (Supplementary Note D5)

The model size calculation device according to any one of Supplementary Notes D1 to D4, in which in the calculation processing, the at least one processor is configured to execute setting the first ideal model size as the target model size.

### (Supplementary Note D6)

The model size calculation device according to any one of Supplementary Notes D1 to D5, in which the at least one processor is further configured to execute output processing of outputting the target model size.

### [Supplementary Information E]

The present disclosure includes technologies described in the following Supplementary Notes. However, the present disclosure is not limited to the techniques described in the following supplementary notes, and various modifications can be made within the scope described in the claims.

### (Supplementary Note E1)

A non-transitory recording medium having stored therein a model size calculation program for causing a computer to function as a model size calculation device, the program causing the computer to function to execute:
acquisition processing of acquiring a first calculation resource amount that is a constraint on a calculation resource amount used for learning processing of a language model for a target language and a target language resource amount that is a resource amount of the target language available in the learning processing;
prediction processing of predicting, in a case where the resource amount of the target language is a first ideal amount according to the first calculation resource amount, a first ideal model size that is a model size for further improving a performance index of the language model in the learning processing using the first calculation resource amount; and
calculation processing of calculating a target model size according to the first calculation resource amount and the target language resource amount with reference to the first ideal model size.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each embodiment can be appropriately combined with at least one of embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

What is claimed is:

1. A model size calculation device comprising:
a memory that stores instructions; and
a processor that is configured, according to the instructions, to execute:
acquiring a first calculation resource amount that is a constraint on a calculation resource amount used for learning processing of a language model for a target language and a target language resource amount that is a resource amount of the target language available in the learning processing;
predicting, in a case where the resource amount of the target language is a first ideal amount according to the first calculation resource amount, a first ideal model size that is a model size for further improving a performance index of the language model in the learning processing using the first calculation resource amount; and
calculating a target model size according to the first calculation resource amount and the target language resource amount with reference to the first ideal model size.

2. The model size calculation device according to claim 1, wherein in the learning processing, a plurality of languages including the target language are used in machine learning.

3. The model size calculation device according to claim 1,
wherein the predicting includes:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

4. The model size calculation device according to claim 1, wherein the calculating includes calculating the target model size by correcting the first ideal model size according to the target language resource amount.

5. The model size calculation device according to claim 1, wherein the calculating includes setting the first ideal model size as the target model size.

6. The model size calculation device according to claim 1, wherein the processor further executes outputting the target model size.

7. A model size calculation method comprising:
acquisition processing of acquiring, by at least one processor, a first calculation resource amount that is a constraint on a calculation resource amount used for learning processing of a language model for a target language and a target language resource amount that is a resource amount of the target language available in the learning processing;
prediction processing of predicting, by the at least one processor in a case where the resource amount of the target language is a first ideal amount according to the first calculation resource amount, a first ideal model size that is a model size for further improving a performance index of the language model in the learning processing using the first calculation resource amount; and
calculation processing of calculating, by the at least one processor, a target model size according to the first calculation resource amount and the target language resource amount with reference to the first ideal model size.

8. The model size calculation method according to claim 7, wherein in the learning processing, a plurality of languages including the target language are used in machine learning.

9. The model size calculation method according to claim 7,
wherein the prediction processing includes:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

10. The model size calculation method according to claim 7, wherein the calculation processing includes calculating the target model size by correcting the first ideal model size according to the target language resource amount.

11. The model size calculation method according to claim 7, wherein the calculation processing includes setting the first ideal model size as the target model size.

12. The model size calculation method according to claim 7, further comprising output processing of outputting the target model size.

13. A non-transitory computer readable medium having stored therein a model size calculation program for supporting decision making for causing a computer to function as a model size calculation device, the program causing the computer to function as:
an acquisition means for acquiring a first calculation resource amount that is a constraint on a calculation resource amount used for learning processing of a language model for a target language and a target language resource amount that is a resource amount of the target language available in the learning processing;
a prediction means for predicting, in a case where the resource amount of the target language is a first ideal amount according to the first calculation resource amount, a first ideal model size that is a model size for further improving a performance index of the language model in the learning processing using the first calculation resource amount; and
a calculation means for calculating a target model size according to the first calculation resource amount and the target language resource amount with reference to the first ideal model size.

14. The non-transitory computer readable medium having stored therein a model size calculation program for supporting decision making according to claim 13, wherein in the learning processing, a plurality of languages including the target language are used in machine learning.

15. The non-transitory computer readable medium having stored therein a model size calculation program for supporting decision making according to claim 13, wherein the prediction means is configured to execute:
calculating a second ideal model size for further improving the performance index of the language model in the learning processing using the second calculation resource amount in a case where the resource amount of the target language is a second ideal amount according to a second calculation resource amount different from the first calculation resource amount; and
predicting the first ideal model size with reference to the second calculation resource amount and the second ideal model size.

16. The non-transitory computer readable medium having stored therein a model size calculation program for supporting decision making according to claim 13, wherein the calculation means is configured to execute calculating the target model size by correcting the first ideal model size according to the target language resource amount.

17. The non-transitory computer readable medium having stored therein a model size calculation program for supporting decision making according to claim 13, wherein the calculation means sets the first ideal model size as the target model size.

18. The non-transitory computer readable medium having stored therein a model size calculation program for supporting decision making according to claim 13, wherein the computer further functions as an output means for outputting the target model size.
